(19) United States
(12) Patent Application Publication
(10) Pub. No.: US 2025/0119685 A1
(43) Pub. Date: Apr. 10, 2025

(54) ULTRASONIC PERSONAL LOCALIZED AUDIO ARRAYS

(71) Applicant: Panasonic Automotive Systems Company of America, Division of Panasonic Corporation of North America, Peachtree City, GA (US)

(72) Inventor: Nicholas Brian HANSEN, Fayetteville, GA (US)

(21) Appl. No.: 18/906,363

(22) Filed: Oct. 4, 2024

Related U.S. Application Data
(60) Provisional application No. 63/588,374, filed on Oct. 6, 2023.

(51) Int. Cl. H04R 1/40; F16M 11/12; H04R 5/02; H04S 7/00

(52) U.S. Cl. CPC H04R 1/403; F16M 11/123; H04R 5/02; H04S 7/302; H04R 2201/025

(57) ABSTRACT

An individualized audio delivery arrangement for a motor vehicle includes an array of ultrasonic transducers mounted on a gimbal. An electronic processor controls an orientation of the gimbal to perform coarse adjustment of a direction in which the array of ultrasonic transducers emits an audio signal. The electronic processor operates the array of ultrasonic transducers as a phased array to perform fine adjustment of the direction in which the array of ultrasonic transducers emits the audio signal.

### CROSS-REFERENCED TO RELATED APPLICATIONS

This application claims benefit of U.S. Provisional Application No. 63/588,374, filed on Oct. 6, 2023, the disclosure of which is hereby incorporated by reference in its entirety for all purposes.

### BACKGROUND OF THE INVENTION

### 1. Field of the Invention

The present invention relates to providing audible infotainment in a motor vehicle.

### 2. Description of the Related Art

Currently, headphones are used to provide different audio signals to various vehicle occupants. However, headphones are not a viable option for drivers and are often objectionable to some other users due to comfort issues and a loss of ambient audio awareness.

### SUMMARY OF THE INVENTION

The present invention, entitled “Ultrasonic Personal Localized Audio Arrays” (UPLAY) is a system including multiple arrays of ultrasonic transducers in conjunction with head tracking systems to provide an occupant in a vehicle with a nearly private listening experience. The inventive UPLAY system may enable the presentation of individualized audio signals to various occupants without requiring the use of physical objects that block ambient audio signals and that can be uncomfortable to some users.

An array of ultrasonic transducers may be used to form an “acoustic laser.” According to the invention, ultrasonic transducers may be configured such that they provide one or more people a nearly private listening experience in a relatively confined space, such as in a vehicle.

The invention may provide at least two “audio lasers” for each occupant in the vehicle. Half of the audio lasers may be used to provide a signal to the occupant's left ear and the other half may be used to provide a signal to the occupant's right ear. Multiple sets of acoustic lasers can be used to provide nearly private listening experiences to multiple occupants in the same vehicle at the same time.

Acoustic lasers work on the principal that an ultrasonic carrier frequency outside of the audible range can be used to excite air molecules at frequencies that are in the audible range. Combining multiple ultrasonic transducers into an array enables a greater amplitude to be achieved at the occupant's ears. Treating the array as a “phased array” also enables the system to “beam form” the signal and fine tune the direction of the signal.

This technique of providing sound to vehicle occupants may work better with higher frequencies than with lower frequencies. Thus, localized subwoofers and/or psychoacoustic techniques may be used to replicate or mimic the lower frequency bass signals.

Hardware and software may track the occupants' head movements and determine the locations of each ear of each occupant. Each of the acoustic lasers may be oriented by a motorized two-axis gimbal to aide in the coarse direction of the signal. The phased array technique may be further used to fine tune the direction of the signal.

The inventive UPLAY system may be utilized in parallel with a classic speaker configuration to provide audio customization options to each occupant while still accommodating the traditional shared listening experience most users are accustomed to. For example, this could include providing prioritized information to the driver without the other occupants being disturbed by hearing the information. As another example, one occupant may be enabled to have higher treble amplitudes than another occupant, which could compensate for an occupant's selective frequency hearing loss.

The inventive UPLAY system may solve problems associated with occupants' competing musical tastes, preferred types of entertainment, volume requirements, and information priority requirements. Imagine a situation in which the driver needs to clearly hear the directions coming from a navigation aide while the other occupants are sleeping. The UPLAY system may send the important audio information to the driver without disturbing the other occupants.

Similarly, all of the occupants may be listening to music and, rather than the navigation aide disturbing the music, the navigation aide could communicate with the driver without the other occupants being disturbed.

Another problem addressed by this system is a situation in which some occupants desire to listen to one style of music while other occupants desire to listen to one or more different styles of music. The UPLAY system may distribute different audio sources to the different occupants.

The invention comprises, in one form thereof, an individualized audio delivery arrangement for a motor vehicle, including an array of ultrasonic transducers mounted on a gimbal. An electronic processor controls an orientation of the gimbal to perform coarse adjustment of a direction in which the array of ultrasonic transducers emits an audio signal. The electronic processor operates the array of ultrasonic transducers as a phased array to perform fine adjustment of the direction in which the array of ultrasonic transducers emits the audio signal.

The invention comprises, in another form thereof, a method for delivering individualized audio in a motor vehicle, including mounting an array of ultrasonic transducers on a gimbal. An orientation of the gimbal is controlled to perform coarse adjustment of a direction in which the array of ultrasonic transducers emits an audio signal. The array of ultrasonic transducers is operated as a phased array to perform fine adjustment of the direction in which the array of ultrasonic transducers emits the audio signal.

The invention comprises, in yet another form thereof, an individualized audio delivery arrangement for a motor vehicle. The arrangement includes a system for detecting the position of an occupant's head. An array of ultrasonic transducers is mounted on a gimbal. An electronic processor is communicatively coupled to the head position detecting system and aims an audio signal from the ultrasonic transducers in a direction toward the head of the occupant of the motor vehicle. The electronic processor controls an orientation of the gimbal to perform coarse adjustment of the direction in which the array of ultrasonic transducers emits an audio signal. The electronic processor operates the array of ultrasonic transducers as a phased array to perform fine adjustment of the direction in which the array of ultrasonic transducers emits the audio signal.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of a vehicle passenger compartment including one embodiment of the ultrasonic personal localized audio arrays of the present invention.

FIG. 2 is a perspective view of one of the ultrasonic transducer arrays of FIG. 1.

FIG. 3 is a schematic diagram of one embodiment of coarse direction adjustment by use of the gimbal of FIG. 2.

FIG. 4 is a schematic diagram of one embodiment of fine location adjustment of the present invention using the ultrasonic transducer array of FIG. 2 as a phased array.

FIG. 5 is a block diagram of the ultrasonic transducer array of FIG. 2 being operated as a phased array for fine adjustment of sound direction.

FIG. 6 is a flow chart of one embodiment of a method of the present invention for delivering individualized audio in a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

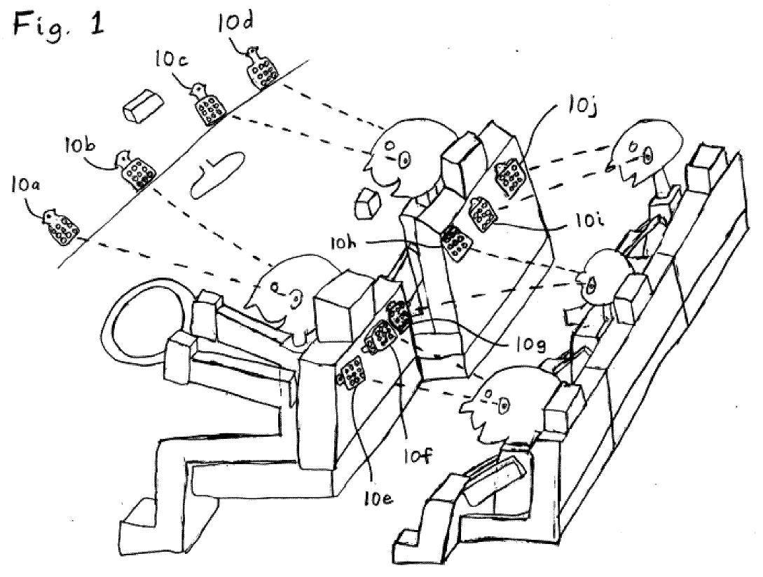

FIG. 1 illustrates one embodiment of a vehicle passenger compartment including one embodiment of the ultrasonic personal localized audio arrays 10a-j of the present invention. Audio arrays 10a-b cause sound to be heard by the driver's left ear and right ear, respectively; audio arrays 10c-d cause sound to be heard by the front seat passenger's left ear and right ear, respectively; audio arrays 10e-f cause sound to be heard by the left rear seat passenger's left ear and right ear, respectively; audio arrays 10g-h cause sound to be heard by the middle rear seat passenger's left ear and right ear, respectively; and audio arrays 10i-j cause sound to be heard by the right rear seat passenger's left ear and right ear, respectively.

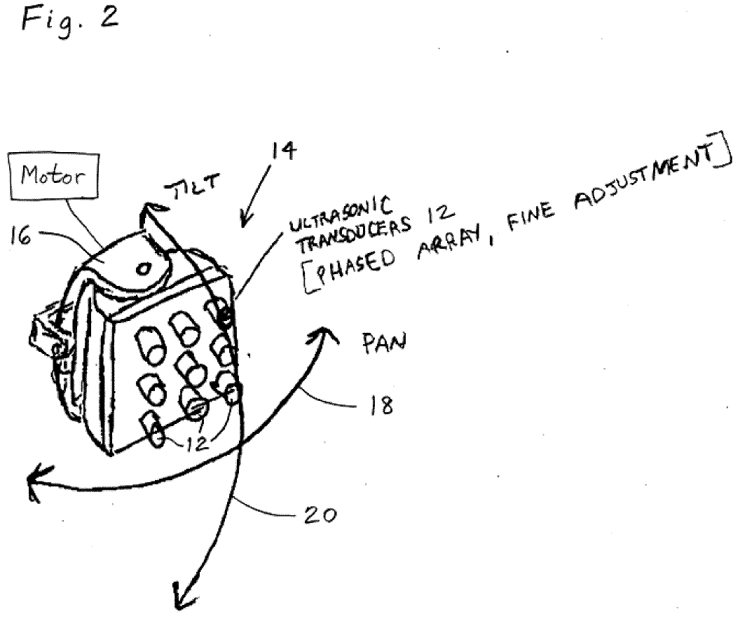

Each one of arrays 10a-j may be in the form of a 3×3 array of ultrasonic transducers 12, as shown in FIG. 2, and may be referred to herein as an “acoustic laser” 14. Each acoustic laser 14 may be a phased array for fine adjustment of the direction of the sound produced thereby.

Each acoustic laser 14 may be mounted on a gimbal 16 that enables acoustic laser 14 to be rotated in pan directions 18 and in tilt directions 20. A motor 21, such as a stepper motor, may be used to drive the rotations of gimbal 16 in directions 18 and 20.

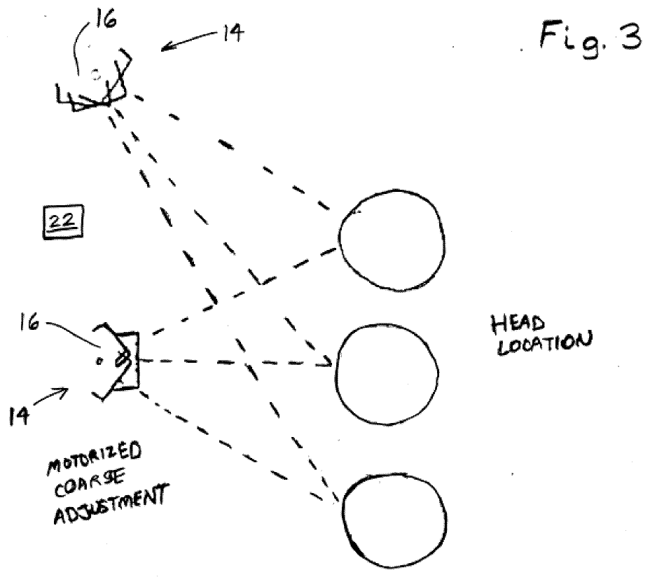

FIG. 3 illustrates one embodiment of coarse direction adjustment by use of gimbals 16. Three different possible lateral head positions are shown. Each gimbal 16 may be rotated in pan directions 18 so that the sound is directed to the current lateral position of the occupant. A conventional system 22 for determining the position of the occupant's head may be employed. System 22 may analyze visual or infrared images, for example, to determine the locations of the occupants' head and/or ears.

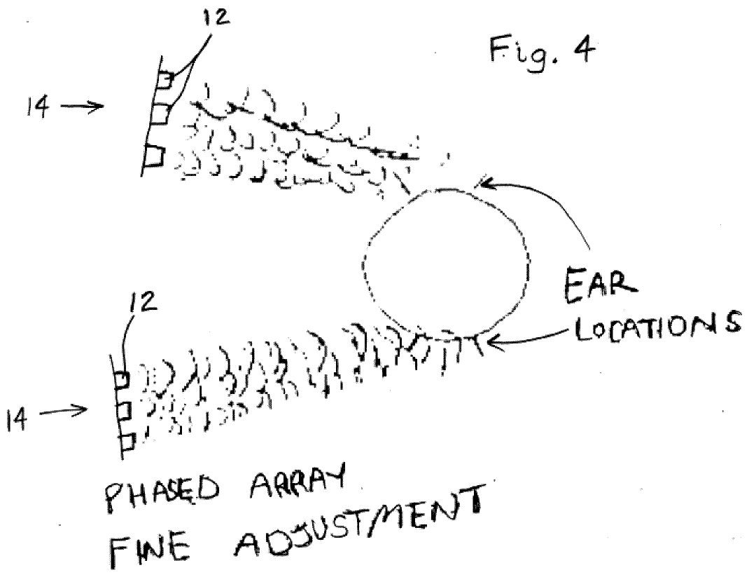

FIG. 4 illustrates one embodiment of fine location adjustment of the sound direction using the phased array of FIG. 2. A phased array transducer is an ultrasonic transducer that contains a series of elements that can be pulsed in a coordinated manner to direct sound waves in a specific direction. Thus, by pulsing ultrasonic transducers 12 in a coordinated manner as a phased array, the direction of the sound may be more precisely directed to an occupant's ear locations.

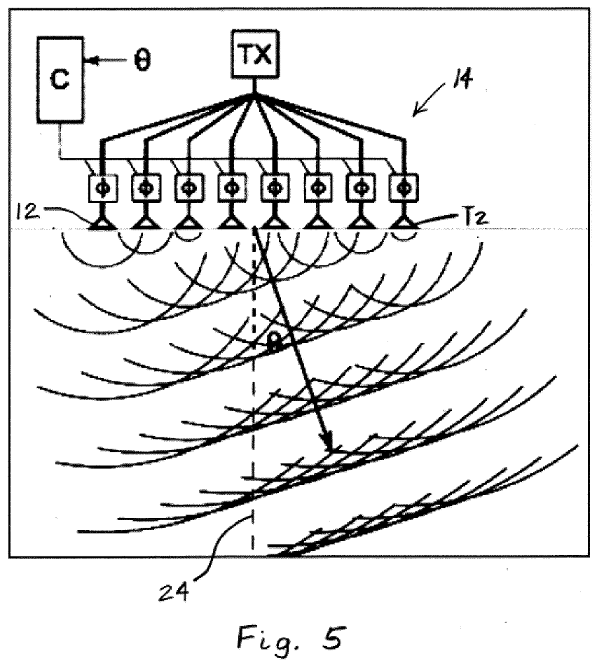

FIG. 5 illustrates ultrasonic transducer array, or “acoustic laser” 14 of FIG. 2 being operated as a phased array for fine adjustment of sound direction. A beamforming oscillator (TX) may produce an electronic signal including pulses of sine waves oscillating at an ultrasonic frequency, which is applied to array 14 of ultrasonic transducers. The timing of the pulses emitted by each transducer 12 is controlled by programmable delay units (q) that are controlled by a microprocessor control system (C). The pulse from each transducer 12 is progressively delayed going down the line from left to right. Each transducer 12 emits its pulse immediately after the one to the left of it. This results in a beam of sound waves emitted at an angle (θ) relative to an imaginary line 24 that is perpendicular to the face of array 14.

Although the array of transducers has been shown herein as being in columns and rows, it is to be understood that the array can be arranged in any pattern (e.g., a honeycomb pattern) or randomly (no pattern) within the scope of the invention.

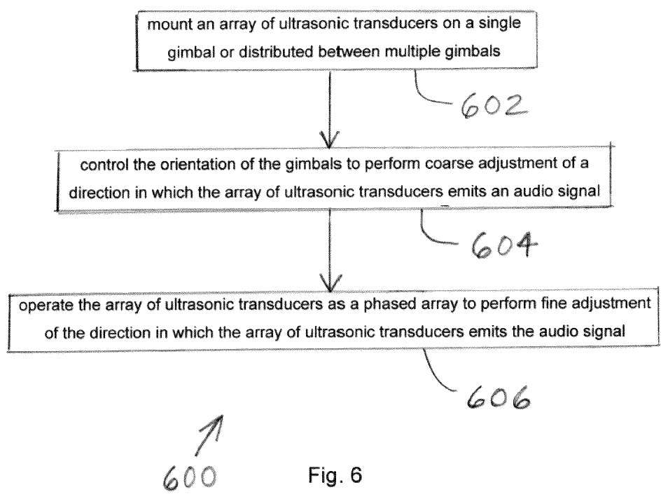

FIG. 6 illustrates one embodiment of a method 600 of the present invention for delivering individualized audio in a motor vehicle. In a first step 602, an array of ultrasonic transducers is mounted on a single gimbal or distributed between multiple gimbals. For example, each of ultrasonic personal localized audio arrays 10a-j may be mounted on a gimbal 16.

Next, in step 604, the orientation of the gimbals is controlled to perform coarse adjustment of a direction in which the array of ultrasonic transducers emits an audio signal. For example, each gimbal 16 may be rotated in pan directions 18 so that the sound is directed to the current lateral position of the occupant.

In a final step 606, the array of ultrasonic transducers is operated as a phased array to perform fine adjustment of the direction in which the array of ultrasonic transducers emits the audio signal. For example, by pulsing ultrasonic transducers 12 in a coordinated manner as a phased array, the direction of the sound may be more precisely directed to an occupant's ear locations.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An individualized audio delivery arrangement for a motor vehicle, the arrangement comprising:
a gimbal;
an array of ultrasonic transducers mounted on the gimbal; and
an electronic processor configured to:
control an orientation of the gimbal to perform coarse adjustment of a direction in which the array of ultrasonic transducers emits an audio signal; and
operate the array of ultrasonic transducers as a phased array to perform fine adjustment of the direction in which the array of ultrasonic transducers emits the audio signal.

2. The arrangement of claim 1 wherein the gimbal is rotatable by the electronic processor in pan directions and tilt directions.

3. The arrangement of claim 1 wherein the direction in which the array of ultrasonic transducers emits an audio signal comprises a direction towards a head of an occupant of the motor vehicle.

4. The arrangement of claim 3 wherein the direction in which the array of ultrasonic transducers emits an audio signal comprises a direction towards an ear of an occupant of the motor vehicle.

5. The arrangement of claim 3 further comprising a system for determining the position of the occupant's head, the system being communicatively coupled to the electronic processor.

6. The arrangement of claim 1 further comprising a beamforming oscillator configured to apply to the array of ultrasonic transducers an electronic signal including pulses of sine waves oscillating at an ultrasonic frequency.

7. The arrangement of claim 1 wherein the electronic processor is configured to control timing of pulses emitted by each said ultrasonic transducer to thereby perform the fine adjustment of the direction in which the array of ultrasonic transducers emits the audio signal.

8. A method for delivering individualized audio in a motor vehicle, the method comprising:
mounting an array of ultrasonic transducers on a single gimbal or distributed between multiple gimbals;
controlling the orientation of the gimbals to perform coarse adjustment of a direction in which the array of ultrasonic transducers emits an audio signal; and
operating the array of ultrasonic transducers as a phased array to perform fine adjustment of the direction in which the array of ultrasonic transducers emits the audio signal.

9. The method of claim 8 wherein the step of controlling an orientation of the gimbal or set of gimbals includes rotating the gimbal or gimbals in pan directions and tilt directions.

10. The method of claim 8 wherein the direction in which the array of ultrasonic transducers emits an audio signal comprises a direction towards a head of an occupant of the motor vehicle.

11. The method of claim 10 wherein the direction in which the array of ultrasonic transducers emits an audio signal comprises a direction towards an ear of an occupant of the motor vehicle.

12. The method of claim 10 further comprising:
determining the position of the occupant's head; and
causing the array of ultrasonic transducers to emit the audio signal toward the occupant's head.

13. The method of claim 8 further comprising applying to the array of ultrasonic transducers an electronic signal including pulses of sine waves oscillating at an ultrasonic frequency.

14. The method of claim 8 further comprising controlling timing of pulses emitted by each said ultrasonic transducer to thereby perform the fine adjustment of the direction in which the array of ultrasonic transducers emits the audio signal.

15. An individualized audio delivery arrangement for a motor vehicle, the arrangement comprising:
a system for detecting a position of a head of an occupant of the motor vehicle;
a gimbal or set of gimbals;
an array of ultrasonic transducers mounted on the gimbal or set of gimbals; and
an electronic processor communicatively coupled to the head position detecting system and configured to:
aim an audio signal from the ultrasonic transducers in a direction toward the head of the occupant of the motor vehicle;
control an orientation of the gimbal or set of gimbals to perform coarse adjustment of the direction in which the array of ultrasonic transducers emits an audio signal; and
operate the array of ultrasonic transducers as a phased array to perform fine adjustment of the direction in which the array of ultrasonic transducers emits the audio signal.

16. The arrangement of claim 15 wherein the gimbal or set of gimbals are rotatable by the electronic processor in pan directions and tilt directions.

17. The arrangement of claim 15 wherein the electronic processor is configured to aim the audio signal from the ultrasonic transducers in a direction toward an ear of an occupant of the motor vehicle.

18. The arrangement of claim 15 further comprising a motor communicatively coupled to the electronic processor and configured to actuate the gimbal.

19. The arrangement of claim 15 further comprising a beamforming oscillator configured to apply to the array of ultrasonic transducers an electronic signal including pulses of sine waves oscillating at an ultrasonic frequency.

20. The arrangement of claim 15 wherein the electronic processor is configured to control timing of pulses emitted by each said ultrasonic transducer to thereby perform the fine adjustment of the direction in which the array of ultrasonic transducers emits the audio signal.
